(19) United States
(12) Patent Application Publication
(10) Pub. No.: US 2026/0325959 A1
(43) Pub. Date: Oct. 22, 2026

(54) SYSTEMS AND METHODS FOR EVENT LOGGING AND REPORTING IN VIDEO GAMES

(71) Applicant: Netflix, Inc., Los Gatos, CA (US)

(72) Inventors: Michael George Cuthbert, IV, San Diego, CA (US); Lexi Shannon Huston, Arlington, MA (US); Timothy Simin Shen, Redonda Beach, CA (US)

(21) Appl. No.: 19/427,655

(22) Filed: Dec. 19, 2025

Related U.S. Application Data
(60) Provisional application No. 63/792,886, filed on Apr. 22, 2025.

(51) Int. Cl. A63F 13/35; A63F 13/40

(52) U.S. Cl. CPC A63F 13/35; A63F 13/40

(57) ABSTRACT

An exemplary method for event logging and reporting in video games involves (1) obtaining, by a server associated with a video game, event definition data that defines an event to be logged in connection with the video game, (2) generating, by the server based at least in part on the event definition data, code configured to cause a game runtime component to log instances of the event that occur in an instance of the video game, (3) providing, by the server, the code to the game runtime component, (4) receiving, by the server from the game runtime component, a record of an instance of the event that occurred in the instance of the video game, and (5) performing, by the server, an action in connection with the video game based at least in part on the record. Various other methods, systems, and computer-readable media are also disclosed.

### CROSS REFERENCE TO RELATED APPLICATION

This application claims the benefit of U.S. Provisional Application No. 63/792,886 filed Apr. 22, 2025, the disclosure of which is incorporated in its entirety by this reference.

### BACKGROUND

Cloud-based video gaming often involves implementing telemetry to understand player behavior, balance costs, and/or modify or operate live content, but some telemetry practices can suffer from deficiencies. For example, telemetry data is often unstructured and inconsistent across different groups, which can undermine analytical reliability and/or lead to poor discoverability because telemetry definitions and/or data are scattered across multiple systems. Moreover, telemetry authors often accidentally choose the wrong kind of analytical storage for their needs. For example, telemetry authors can lack coordinated support for both durable, long-term analytics and fast, low-latency queries.

Unfortunately, these deficiencies can impede reliable analysis and/or effective use of gaming telemetry. The instant disclosure, therefore, identifies and addresses a need for improved systems and methods for event logging and reporting in video games.

### SUMMARY

As will be described in greater detail below, the present disclosure describes systems and methods for event logging and reporting in video games. In some examples, a method for providing and implementing gaming analytics involves (1) obtaining, by a server associated with a video game, event definition data that defines an event to be logged in connection with the video game, (2) generating, by the server based at least in part on the event definition data, code configured to cause a game runtime component to log instances of the event that occur in an instance of the video game, (3) providing, by the server, the code to the game runtime component, (4) receiving, by the server from the game runtime component, a record of an instance of the event that occurred in the instance of the video game, and (5) performing, by the server, an action in connection with the video game based at least in part on the record.

In some examples, the method also involves storing, by the server, the record of the instance of the event in an analytical storage destination to facilitate analyzing the record. In one example, the method further involves performing the action based at least in part on the analysis of the record. In certain implementations, the method additionally involves identifying, by the server, a unique identifier included in the event definition data. Additionally or alternatively, the method involves generating the code to cause the game runtime component to include the unique identifier in the record of the instance of the event and designating the analytical storage destination to store records that include the unique identifier.

In some examples, the event definition data includes a schema that models the event, and a version identifier corresponds to a specific version of the schema. In one example, the method also involves identifying, by the server, a selected programming language and a type of operating environment indicated in the event definition data. In this example, the method further involves generating a language-specific code package for execution in the selected programming language and initialized for the type of operating environment. Additionally or alternatively, the method involves providing the code package to the game runtime component for execution in the type of operating environment in connection with the instance of the video game.

Examples of the selected programming language include, without limitation, an object-oriented language, a mobile platform language, a game engine scripting language, a visual scripting language, combinations of one or more of the same, and any other suitable programming language. Examples of the type of operating environment include, without limitation, a production environment, a staging environment, a software development environment, a sandbox environment, a quality assurance environment, combinations of one or more of the same, and any other suitable type of operating environment.

In some examples, the method also involves identifying, by the server, a selected reporting mechanism in the event definition data. In one example, the method further involves generating the code to cause the game runtime component to report the record of the instance of the event to the server via the selected reporting mechanism. In this example, the method additionally involves receiving the record of the instance of the event from the game runtime component via the selected reporting mechanism.

In some examples, the selected reporting mechanism includes a schema that models the event, and a version identifier corresponds to a specific version of the schema. Examples of the selected reporting mechanism include, without limitation, a software development kit (SDK) interface, a web application programming interface (API), a client library interface, combinations of one or more of the same, and any other suitable selected reporting mechanism.

In some examples, the method also involves creating, by the server, a per-event reporting pipeline based at least in part on the event definition data. In one example, the method does so by creating a telemetry topic associated with the event, designating an analytical storage destination to store records received via the telemetry topic, and registering, on the server, a synchronization process configured to route the records received via the telemetry topic into the analytical storage destination.

In some examples, the method also involves publishing the record of the instance of the event to the telemetry topic and implementing the synchronization process to route the record from the telemetry topic into the analytical storage destination. Examples of the action include, without limitation, updating a configuration store of the video game to adjust gameplay parameters based at least in part on the record, generating a dashboard that visualizes records stored in an analytical storage destination, updating matchmaking parameters or pairing rules to influence player pairing based at least in part on the record, modifying economy parameters or store offers in connection with the video game based at least in part on the record, combinations or variations of one or more of the same, and any other suitable action.

In some examples, the method also involves receiving the event definition data from a user interface that is hosted by the server and through which a user defines the event. In one example, the method further involves receiving the event definition data from a dynamic-events workflow from which the server derives the event definition data based at least in part on a logged payload enqueued in a dead-letter queue.

In some examples, a corresponding system includes at least one storage device and circuitry that is incorporated into a server associated with the video game. In one example, the storage device is configured to store records of select events that occur in a video game. In this example, the circuitry is configured to (1) obtain event definition data that defines an event to be logged in connection with the video game, (2) generate, based at least in part on the event definition data, code configured to cause a game runtime component to log instances of the event that occur in an instance of the video game, (3) provide the code to the game runtime component, (4) receive, from the game runtime component, a record of an instance of the event that occurred in the instance of the video game, and (5) perform an action in connection with the video game based at least in part on the record.

In some examples, a non-transitory computer-readable medium comprises one or more computer-executable instructions that, when executed by circuitry of a server, cause the server to (1) obtain event definition data that defines an event to be logged in connection with a video game, (2) generate, based at least in part on the event definition data, code configured to cause a game runtime component to log instances of the event that occur in an instance of the video game, (3) provide the code to the game runtime component, (4) receive, from the game runtime component, a record of an instance of the event that occurred in the instance of the video game, and (5) perform an action in connection with the video game based at least in part on the record.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates an exemplary system for event logging and reporting in video games in accordance with one or more implementations of this disclosure.

FIG. 2 illustrates an exemplary system for event logging and reporting in video games in accordance with one or more implementations of this disclosure.

FIG. 3 illustrates an exemplary flow diagram for event logging and reporting in video games in accordance with one or more implementations of this disclosure.

FIG. 4 illustrates an exemplary implementation of systems and methods for event logging and reporting in video games in accordance with one or more embodiments of this disclosure.

FIG. 5 illustrates an exemplary method for event logging and reporting in video games in accordance with one or more implementations of this disclosure.

FIG. 6 illustrates a block diagram of an exemplary content distribution ecosystem.

FIG. 7 illustrates a block diagram of an exemplary distribution infrastructure within the content distribution ecosystem shown in FIG. 6.

FIG. 8 illustrates a block diagram of an exemplary content player within the content distribution ecosystem shown in FIG. 7.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

Video game teams (e.g., analysts, developers, engineers, designers, etc.) need reliable data about how players interact with their video games in order to better understand player behavior, balance costs, and/or modify or operate live content associated with the video games. Unfortunately, such data is often defined inconsistently, logged ad hoc, and/or scattered across systems that are difficult for non-engineers to use. Even when they agree on which metrics to log, the game teams have to manually configure data pipelines, write custom client code for logging events, and/or clean up unstructured schemas (e.g., JavaScript Object Notation (JSON) schemas). As a result, the game teams' process of converting an idea (e.g., “let's track button clicks”) into reliable, analyzable data can be slow and/or error-prone.

To address these deficiencies of gaming analytics platforms, the systems and methods described herein can involve turning event ideas into end-to-end telemetry with minimal effort. For example, a team defines an event and its typed fields in a web interface of an analytics platform. In response, the analytics platform can automatically prepare the downstream data pipeline for that event. In this example, the data pipeline creates a dedicated telemetry stream and/or configures analytical tables to store data associated with instances of the event. When a team requests client integration in connection with a cloud-based game, the platform generates a ready-to-use code package tailored to a selected language and/or runtime environment (e.g., a game engine and/or mobile platform) so that the game can immediately start logging instances of the event.

At runtime, the game client executes the code package to send event records to the server. At the server, the data pipeline implements a routing process that steers the event records to channels corresponding to the correct analytical storage destinations. In some examples, the data pipeline implements a synchronization process that validates each event record against the event definition, attaches version information, and then writes the event record into the correct analytical storage destinations for both long-term analysis and dashboard-style queries. In one example, if an unknown event record arrives, the server can capture the record in a dead-letter queue and/or derive a suitable event definition from the record. In this example, the server can create a data pipeline for the event and then reprocess the record to prevent data loss.

In some examples, the analytics platform emphasizes and/or improves consistency and reuse across events and/or teams. In one example, every change to an event is versioned in the corresponding JSON schema, and the version identifier flows through the code package into stored records so that analysts can interpret historical data correctly as the schemas evolve. In this example, the analytics platform effectively provides a workflow that allows non-engineers to model events, developers to integrate event logging quickly across multiple programming languages and engines, and teams to access trustworthy data within minutes. Moreover, the analytics platform can provide a bootstrapped dashboard that presents meaningful information derived from the event records, and the teams can tune gameplay, operate live content, detect anomalies, and/or make informed economic decisions based on such information.

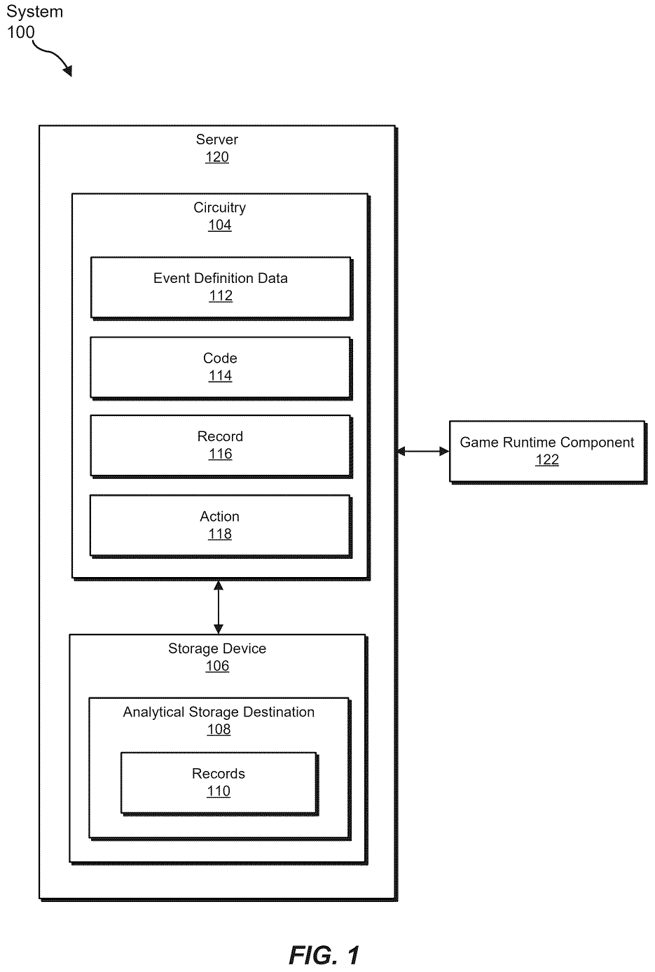

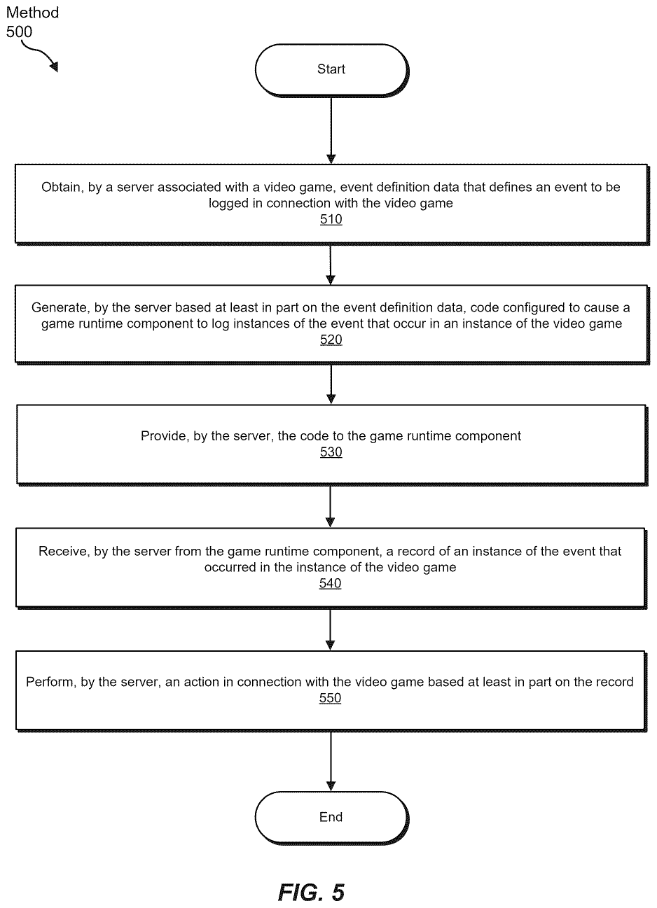

The following will provide, with reference to FIGS. 1-4 and 6-8, detailed descriptions of exemplary devices, systems, and corresponding implementations or configurations that facilitate and/or support event logging and reporting in video games. The following will also provide, with reference to FIG. 5, examples of methods for supporting event logging and reporting in video games.

FIG. 1 illustrates an exemplary system 100 for event logging and reporting in video games. In some examples, system 100 includes and/or represents a server 120 and/or a game runtime component 122 communicatively coupled to one another. In one example, server 120 includes and/or represents circuitry 104 and/or a storage device 106 that interface with and/or are communicatively coupled to one another. In this example, system 100 can implement, provide, and/or constitute at least part of a gaming analytics platform and/or a games event service (GES). In certain implementations, circuitry 104 and/or storage device 106 are incorporated into and/or deployed as part of a server associated with a video game (e.g., a cloud-based video game). Additionally or alternatively, circuitry 104 and/or storage device 106 are incorporated into and/or deployed as part of game runtime component 122 associated with such a video game.

In some examples, game runtime component 122 includes and/or represents a client device that executes an instance of the video game. In one example, game runtime component 122 includes and/or represents an internal game server that runs services related to the video game and/or provides game-related telemetry data. Additionally or alternatively, game runtime component 122 includes and/or represents an external and/or third-party game server that runs services related to the video game and provides game-related telemetry data.

In some examples, storage device 106 stores, maintains, and manages records 110 of select events that occur in a video game. In one example, storage device 106 includes and/or represents various locations and/or destinations that are dedicated, designated, and/or configured to store or maintain records corresponding to specific events that occur in video games. For example, storage device 106 can include and/or represent an analytical storage destination 108 designated to store records 110 of instances of a specific event that occurs in a video game played on a specific end-user device and/or across various end-user devices.

In some examples, circuitry 104 obtains and/or receives event definition data 112 that defines and/or describes an event to be tracked and/or logged in connection with the video game. In one example, circuitry 104 generates code 114 based at least in part on event definition data 112. For example, code 114 is configured and/or designed to cause game runtime component 122 to track and/or log any instances of the event that occur in the instance of the video game. In this example, circuitry 104 provides, delivers, and/or transmits code 114 to the client.

Examples of the types of events that can be defined and/or described in event definition data 112 include, without limitation, gameplay progression events (e.g., tutorial steps, levels started or completed, mission milestones, etc.), economy or transaction events (e.g., currency earned or spent, items acquired or consumed, store interactions, etc.), user interface or interaction events (e.g., button clicks, menu navigation, screen impressions, etc.), combat or ability events (e.g., shots fired, hits or misses, damage dealt or taken, ability cast or cooldowns, etc.), social or multiplayer events (e.g., matchmaking requests or results, party joins or exits, friend invites, etc.), session or device events (e.g., game start or quit, session duration, environment configurations, etc.), world or state events (e.g., entity spawns or defeats, map loads or unloads, objective state changes, etc.), experimentation events (e.g., treatment exposure, experiment checkpoints, etc.), telemetry health or validation events (e.g., schema version markers, dead-letter occurrences, etc.), developer debugging events (e.g., diagnostic logs, performance counters, etc.), combinations or variations of one or more of the same, and/or any other suitable events.

In some examples, circuitry 104 identifies and/or locates a unique identifier included in event definition data 112. In one example, this unique identifier is used to identify, denote, and/or represent the specific event defined and/or described in event definition data 112. In this example, circuitry 104 generates and/or builds code 114 such that code 114 causes the client to insert and/or include the unique identifier in records 110. Additionally or alternatively, analytical storage destination 108 can be designated to store all incoming records that include and/or contain the unique identifier. In certain implementations, the unique identifier can identify the event itself and/or the specific version of a schema that models the event.

In some examples, circuitry 104 identifies and/or locates a selected programming language and/or a type of operating environment indicated in event definition data 112. In one example, circuitry 104 generates and/or builds a language-specific code package for execution in the selected programming language. In this example, the language-specific code package is initialized for the type of operating environment indicated in event definition data 112. In certain implementations, circuitry 104 provides the language-specific code package to the client for execution in the type of operating environment in connection with the instance of the video game.

Examples of the selected programming language include, without limitation, an object-oriented language, a mobile platform language, a game engine scripting language, a visual scripting language, combinations or variations of one or more of the same, and/or any other suitable programming language. Examples of the type of operating environment include, without limitation, a production environment, a staging environment, a software development environment, a sandbox environment, a quality assurance environment, combinations or variations of one or more of the same, and/or any other suitable type of operating environment.

In some examples, circuitry 104 identifies and/or locates a selected reporting mechanism in event definition data 112. In one example, circuitry 104 generates and/or builds code 114 such that code 114 causes the client to report all records of instances of the specific event to server 120. In certain implementations, the selected mechanism includes and/or represents a schema (e.g., a JSON schema) that models the event defined and/or described in event definition data 112, and the unique identifier corresponds to and/or identifies a specific version of the schema. Examples of the selected reporting mechanism include, without limitation, a software development kit (SDK) interface, a web application programming interface (API), a client library interface, combinations or variations of one or more of the same, and/or any other suitable reporting mechanism.

In some examples, circuitry 104 receives and/or obtains a record 116 of an instance of the event defined and/or described in event definition data 112. In one example, the instance of the event represented in record 116 occurred in the instance of the video game executed by and/or played on the client. Additionally or alternatively, circuitry 104 performs one or more actions in connection with the video game based at least in part on record 116. For example, circuitry 104 can perform an action 118 to improve one or more parameters and/or features of the video game based at least in part on record 116.

Examples of action 118 include, without limitation, updating gameplay parameters of the video game (e.g., difficulty multipliers, spawn rates, drop rates, tutorial gating, etc.), modifying economy settings or offers related to the video game (e.g., prices, rewards, bundle composition, availability windows, etc.) based on spending and/or earning patterns, adjusting matchmaking rules and/or weights (e.g., skill estimates, queue selections, regional routing, etc.) to improve fairness and match quality, modifying live operations (e.g., limited-time events, content rotations, reward schedules, etc.) in response to participation data, generating or rendering dashboards and/or reports that visualize key metrics derived from records, triggering anti-bot and/or fraud mitigations (e.g., throttling, rate limiting, additional verification, account flags or suspensions, etc.) in response to suspicious patterns, producing recommendations and/or content selections (e.g., quests, modes, items to surface, etc.) tailored to player behavior, sending instructions to the client to enable, disable, and/or modify features of the video game, initiating diagnostic and/or remedial actions (e.g., raise alerts, increase logging verbosity, roll back a feature flag, etc.) in response to error and/or health signals in records, combinations or variations of one or more of the same, and/or any other suitable action.

In some examples, storage device 106 includes and/or represents any type or form of volatile or non-volatile storage device or medium capable of storing data and/or computer-readable instructions. In one example, storage device 106 maintains and/or stores one or more computer-readable instructions, modules, programs, and/or applications. Examples of storage device 106 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable memory. Although illustrated as a single unit in FIG. 1, storage device 106 can alternatively include and/or represent a collection of multiple storage devices capable of storing and/or maintaining data used in event logging and reporting in video games. In certain implementations, storage device 106 is used to provide, facilitate, and/or support various data architectures, including data lakes, ICEBERG tables, DRUID tables, analytics and/or telemetry stores, etc.

In some examples, circuitry 104 includes and/or represents one or more electrical and/or electronic circuits capable of processing, applying, modifying, transforming, simulating, generating, displaying, transmitting, receiving, and/or executing data for system 100. In one example, circuitry 104 accesses and/or analyzes data stored in storage device 106 to facilitate and/or support event logging and reporting in video games. Additionally or alternatively, circuitry 104 launches, performs, and/or executes certain executable files, code snippets, and/or computer-readable instructions to facilitate and/or support event logging and reporting in video games.

Although illustrated as a single unit in FIG. 1, circuitry 104 can include and/or represent a collection of multiple processing units and/or electrical or electronic components that work and/or operate in conjunction with one another. Examples of circuitry 104 include, without limitation, processing devices, hardware processors, microprocessors, microcontrollers, field-programmable gate arrays (FPGAs), application-specific integrated circuits (ASICs), graphics processing units (GPUs), central processing units (CPUs), systems on chips (SoCs), parallel accelerated processors, tensor cores, integrated circuits, chiplets, receivers, transmitters, transceivers, storage devices, memory devices, digital logic, analog circuitry, digital circuitry, portions of one or more of the same, variations or combinations of one or more of the same, and/or any other suitable circuitry. In certain implementations, circuitry 104 can be distributed across multiple devices (e.g., servers, computing devices, etc.).

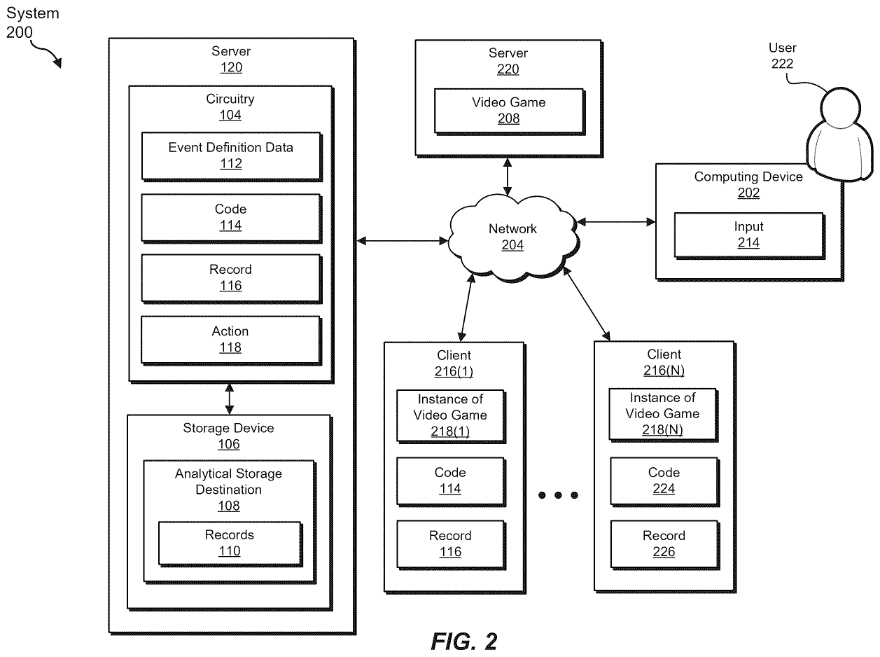

FIG. 2 illustrates an exemplary system 200 that facilitates and/or supports event logging and reporting in video games. In some examples, system 200 in FIG. 2 includes and/or involves certain devices, components, configurations, and/or features that perform and/or provide functionalities that are similar and/or identical to those described above in connection with FIG. 1. In one example, system 200 includes and/or represents a server 120, a server 220, a computing device 202, and/or clients 216(1)-(N). In this example, server 120, server 220, computing devices 202, and/or clients 216(1)-(N) can communicate with one another via a network 204. In certain implementations, server 120 includes and/or represents circuitry 104 and/or storage device 106, which enable server 120 to perform or implement the techniques, actions, and/or features described in connection with FIG. 2.

In some examples, a media streaming platform can include and/or represent server 220 and/or portions of network 204, among other devices that are not necessarily illustrated in FIG. 2. In one example, server 220 can store and/or provide video game 208 for streaming to clients 216(1)-(N) via network 204. For example, the media streaming platform can stream, transmit, and/or provide video game 208 to clients 216(1)-(N). In certain implementations, clients 216(1)-(N) correspond to different users playing instances 218(1)-(N), respectively, of video game 208. Additionally or alternatively, system 200 and/or server 120 can implement and/or apply the event logging and reporting in video games techniques described herein in connection with video game 208 and/or instances 218(1)-(N).

In some examples, computing device 202 can support and/or facilitate entry of input 214 by a user 222. In such examples, computing device 202 receives and/or obtains input 214 indicating, describing, and/or defining one or more events to track and/or log in connection with video game 208 and/or one or more of instances 218(1)-(N). For example, input 214 can include and/or represent information that describes and/or defines a select event to track and/or log in connection with instance 218(1) of video game 208. In one example, computing device 202 generates and/or produces event definition data 112 based at least in part on input 214. In this example, computing device 202 provides, delivers, and/or transmits event definition data 112 to server 120 via network 204. In certain implementations, event definition data 112 is formatted as a JSON file and/or payload. Additionally or alternatively, server 120 can transform and/or convert event definition data 112 from an original format into a JSON file and/or payload.

In some examples, computing device 202 provides, delivers, and/or transmits input 214 to server 120 via network 204. In one example, upon receiving input 214, server 120 generates and/or produces event definition data 112 based at least in part on input 214. Additionally or alternatively, server 120 creates and/or configures a per-event reporting pipeline based at least in part on event definition data 112. In certain implementations, server 120 creates and/or configures various other per-event reporting pipelines based at least in part on various other event definition data.

In some examples, server 120 includes, represents, and/or hosts a user interface through which a user defines the event. Additionally or alternatively, server 120 implements and/or applies a dynamic-events workflow to derive event definition data 112 based at least in part on a logged payload loaded in a dead-letter queue.

In some examples, server 120 creates and/or configures a telemetry topic associated with the event defined in event definition data 112 for the per-event reporting pipeline. In one example, server 120 designates and/or reserves analytical storage destination 108 for storing records 110 received via the telemetry topic. In this example, server 120 registers and/or applies a synchronization process for routing records 110 received via the telemetry topic into analytical storage destination 108.

In some examples, server 120 receives event definition data 112 from computing device 202 via network 204. In one example, server 120 generates code 114 based at least in part on event definition data 112. For example, code 114 is configured and/or designed to cause client 216(1) executing instance 218(1) of video game 208 to track and/or log any instances of the corresponding event that occur in instance 218(1). In this example, server 120 provides, delivers, and/or transmits code 114 to client 216(1) via network 204.

In some examples, client 216(1) executes code 114 in connection with instance 218(1) of video game 208. In one example, while implementing instance 218(1) of video game 208, client 216(1) detects an instance of the event defined in event definition data 112 based at least in part on code 114. In this example, client 216(1) then generates and/or produces record 116 to represent the detected instance of that event based at least in part on code 114. Additionally or alternatively, client 216(1) provides, delivers, and/or transmits record 116 to server 120 via network 204.

In some examples, server 120 receives record 116 of the instance of the event defined and/or described in event definition data 112 from client 216(1). In one example, server 120 performs one or more actions in connection with video game 208 based at least in part on record 116. For example, server 120 can perform action 118 to improve one or more parameters and/or features of video game 208 based at least in part on record 116.

In some examples, server 120 publishes record 116 of the instance of the event to the telemetry topic in the per-event reporting pipeline. In one example, server 120 implements a synchronization process that routes record 116 from the telemetry topic into analytical storage destination 108 of storage device 106.

In some examples, server 120 creates and/or configures another telemetry topic associated with another event defined in other event definition data for another per-event reporting pipeline. In one example, server 120 designates and/or reserves another analytical storage destination in storage device 106 for storing records received via the other telemetry topic. In this example, server 120 registers and/or applies another synchronization process for routing the records received via the other telemetry topic into the other analytical storage destination.

In some examples, server 120 receives additional event definition data from computing device 202 or another computer device (not necessarily illustrated in FIG. 2) via network 204. In one example, server 120 generates code 224 based at least in part on the event defined in the additional definition data. For example, code 224 is configured and/or designed to cause client 216(N) executing instance 218(N) of video game 208 to track and/or log any instances of the corresponding event that occur in instance 218(N). In this example, server 120 provides, delivers, and/or transmits code 224 to client 216(N) via network 204.

In some examples, client 216(N) executes code 224 in connection with instance 218(N) of video game 208. In one example, while implementing instance 218(N) of video game 208, client 216(N) detects an instance of the event defined in the additional event definition data based at least in part on code 224. In this example, client 216(N) then generates and/or produces a record 226 to represent the detected instance of that event based at least in part on code 224. Additionally or alternatively, client 216(N) provides, delivers, and/or transmits record 226 to server 120 via network 204.

In some examples, server 120 receives record 226 of the instance of the event defined and/or described in the additional event definition data from client 216(N). In one example, server 120 performs one or more actions in connection with video game 208 based at least in part on record 226. For example, server 120 can perform an action to improve one or more parameters and/or features of video game 208 based at least in part on record 226.

In some examples, server 120 publishes record 226 to the corresponding telemetry topic in the corresponding per-event reporting pipeline. In one example, server 120 implements a synchronization process that routes record 226 from that telemetry topic into analytical storage destination 108 or another analytical storage destination of storage device 106.

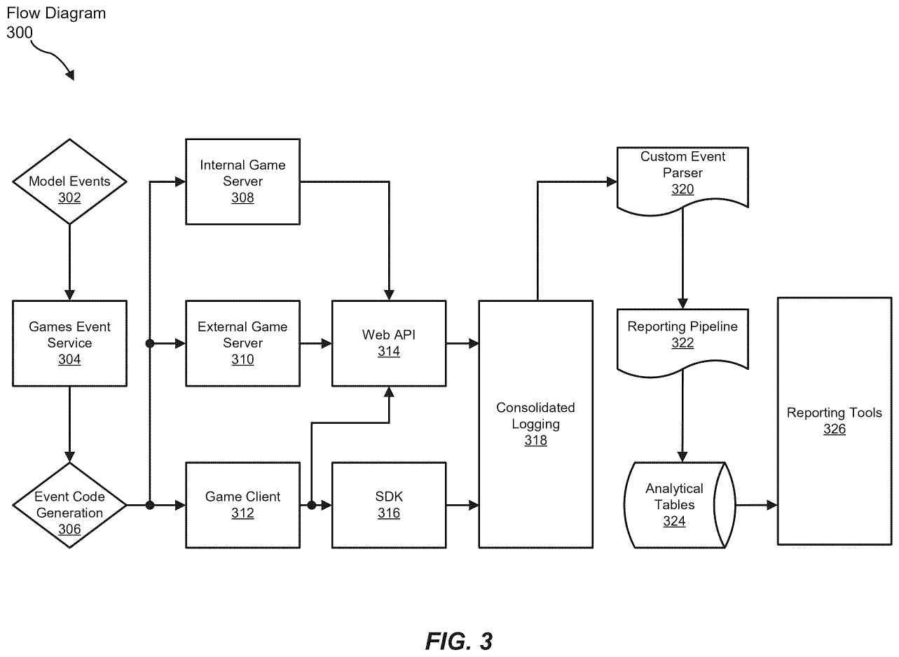

FIG. 3 illustrates an exemplary flow diagram 300 for a gaming analytics platform. In some examples, flow diagram 300 in FIG. 3 includes and/or involves one or more processes, tasks, and/or operations that are similar and/or identical to those described above in connection with FIG. 1 and/or FIG. 2. In one example, flow diagram 300 can be performed by any of the devices, components, and/or systems described in FIG. 1 and/or FIG. 2.

In some examples, flow diagram 300 includes and/or involves modeling one or more events that occur in a video game based at least in part on input obtained from a user (302). In one example, flow diagram 300 also includes and/or involves providing event definition data corresponding to the modeled events to a GES, which then creates and/or provisions per-event reporting pipelines for such events (304). In this example, the event definition data is modeled using a composition-first approach that promotes consistency across events and game teams. For example, the GES can enable a user to define shared, typed properties at the game scope and to reference those properties across multiple events. Additionally or alternatively, the user can define reusable structs (e.g., a “common data” struct) that encapsulate fields intended to appear with many events and then compose those structs into individual event definitions. In certain implementations, composing shared properties and reusable structs help ensure that certain concepts use the same names and/or types across events.

In some examples, the GES maintains a lifecycle for each event definition that includes a draft state. For example, a user can create and/or modify an event in draft, promote the draft to an active state when ready, and/or delete the draft. In one example, flow diagram 300 further includes and/or involves generating code configured to cause one or more clients executing instances of the video game to log instances of the events that occur in the video game (306). In this example, code packages are generated on-demand and/or upon request rather than being prebuilt. For example, in response to a user request specifying an event set, a selected programming language, and/or an operating environment, a server can produce a language-specific package that reflects the current event definitions and returns the package to the requester.

In some examples, flow diagram 300 includes and/or involves an internal game server that executes the code and/or applies corresponding game logic to output and/or report records of event instances that occur in the video game (308). In one example, flow diagram 300 also includes and/or involves an external game server that executes the code to output and/or report records of event instances that occur in the video game (310). Additionally or alternatively, flow diagram 300 also includes and/or involves a game client that executes the code to output and/or report records of event instances that occur in the video game (312).

In some examples, flow diagram 300 includes and/or involves a web application programming interface (API) through which the internal or external game server reports records of the event instances to a telemetry server (314). In one example, the web API provides a telemetry ingress that receives event records over a network and/or forwards the event records for routing and storage. Additionally or alternatively, the web API is preconfigured with endpoint identifiers and/or environment parameters so that the event records reported by the game client are directed to the appropriate per-event reporting pipelines.

In some examples, flow diagram 300 includes and/or involves a software development kit (SDK) that exposes a logging interface for the game client to report records of the event instances to the telemetry server (316). In one example, the SDK is integrated into the game client and implements logging functions, credential handling, and/or environment-specific configurations. Additionally or alternatively, the SDK operates in lieu of the web API and/or provides an alternative reporting mechanism selected by the user.

In some examples, flow diagram 300 includes and/or involves consolidated logging that ingests records reported via the web API and/or SDK and normalizes transport-level details for downstream processing (318). In one example, the consolidated logging feature buffers, validates, and forwards the records to telemetry topics created for the events in the reporting pipelines. Additionally or alternatively, the consolidated logging feature applies organization-wide conventions to ensure that the event records are compatible with subsequent routing and/or synchronization on the telemetry server.

In some examples, flow diagram 300 includes and/or involves a custom event parser that evaluates event records against the event definition data and performs schema-aware validation and enrichment (320). In one example, the custom event parser identifies records that fail to conform to any known event schema and enqueues such records in a dead-letter queue for later derivation of event definition data. Additionally or alternatively, the custom event parser attaches version identifiers, shared properties, and/or environment metadata to conforming records prior to routing.

In some examples, flow diagram 300 includes and/or involves a reporting pipeline that binds per-event telemetry topics to corresponding analytical storage destinations (322). In one example, the reporting pipeline registers and implements a synchronization process that routes records from the telemetry topics into analytical tables. Additionally or alternatively, the reporting pipeline mirrors records into a low-latency analytics store to support interactive dashboards.

In some examples, flow diagram 300 includes and/or involves analytical tables that persist records of event instances in a durable, queryable format (324). In one example, the analytical tables comprise lakehouse-style tables that store records together with version identifiers and/or environment metadata to facilitate reliable analysis across schema changes. Additionally or alternatively, the analytical tables are named according to a convention derived from the video game and/or event identifiers to improve discoverability.

In some examples, flow diagram 300 includes and/or involves reporting tools that visualize and/or analyze the records stored in the analytical tables (326). In one example, the reporting tools automatically generate dashboards associated with the video game that present metrics derived from the records of event instances. Additionally or alternatively, the reporting tools enable stakeholders to perform funnel analysis, economy monitoring, matchmaking evaluation, anomaly detection, and/or other analyses based at least in part on the records stored in the analytical tables.

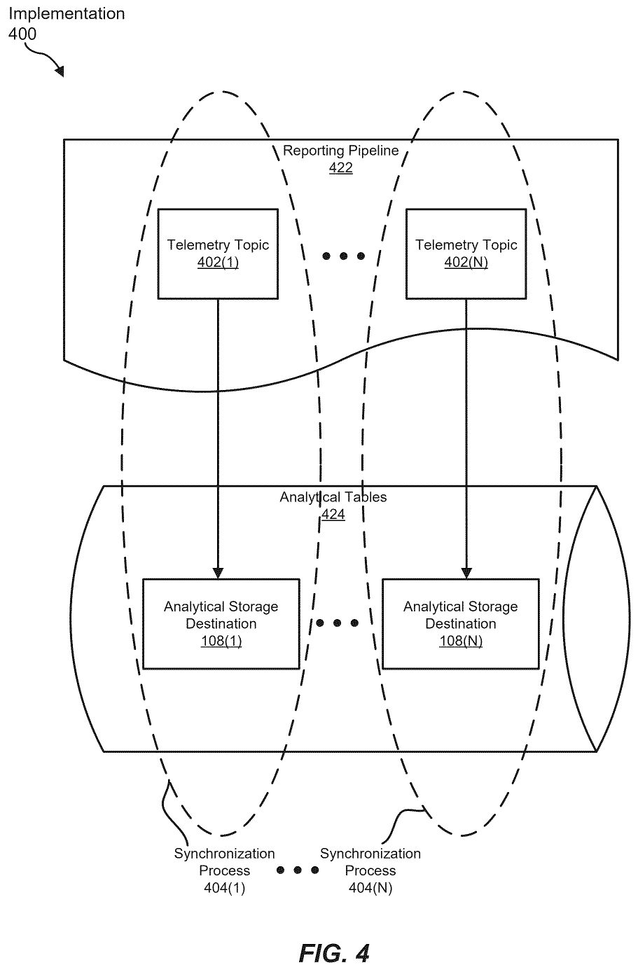

FIG. 4 illustrates an exemplary implementation 400 of a per-event reporting pipeline that binds telemetry topics to analytical storage destinations via registered synchronization processes. In some examples, implementation 400 in FIG. 4 includes and/or involves one or more processes, tasks, and/or operations that are similar and/or identical to those described above in connection with any of FIGS. 1-3. In one example, implementation 400 can be performed by any of the devices, components, and/or systems described in FIGS. 1-3. For example, server 120 can implement and/or establish reporting pipeline 422 with telemetry topics 402(1)-(N).

In some examples, reporting pipeline 422 includes and/or represents telemetry topics 402(1)-(N) that are each associated with an event defined in event definition data. In one example, server 120 publishes event records to the corresponding telemetry topic in reporting pipeline 422. In one example, server 120 executes, implements, and/or applies synchronization processes 404(1)-(N) that route records from telemetry topics 402(1)-(N) into analytical storage destinations 108(1)-(N), respectively, in analytical tables 424 of storage device 106.

In some examples, reporting pipeline 422 includes and/or represents telemetry topics for different events, environments, and/or partitions to facilitate scalable ingestion and routing of event records. In one example, analytical tables 424 include and/or represent durable, queryable tables that persist event records together with version identifiers and/or environment metadata to enable reliable analysis across schema changes.

In some examples, synchronization processes 404(1)-(N) are registered on server 120 to route event records received via telemetry topics 402(1)-(N) into corresponding analytical storage destinations 108(1)-(N). In one example, synchronization process 404(1) subscribes to telemetry topic 402(1), validates and/or normalizes records in view of the event schema, and then writes the records into analytical storage destination 108(1). Additionally or alternatively, each synchronization process can be configured per event to enforce typing, to attach version identifiers, and/or to handle error conditions by diverting invalid records to a dead-letter queue for subsequent reprocessing.

In some examples, implementation 400 provides isolation and scalability at the event level by maintaining distinct telemetry topics, analytical storage destinations, and/or synchronization processes for different events. In one example, this per-event telemetry facilitates and/or supports independent monitoring, throughput control, and/or schema-aware validation for each event while preserving a consistent naming convention across reporting pipeline 422 and analytical tables 424. Additionally or alternatively, implementation 400 mirrors selected records into auxiliary analytical storage destinations to support low-latency dashboards in parallel with long-term analytical tables.

In some examples, the various systems, components, and/or features described in connection with FIGS. 1-4 can include and/or represent one or more additional circuits, components, and/or features that are not necessarily illustrated and/or labeled in FIGS. 1-4. For example, the systems, components, and/or features illustrated in FIGS. 1-4 can also include and/or represent additional analog and/or digital circuitry, onboard logic, transistors, radio-frequency (RF) transmitters, RF receivers, transceivers, antennas, resistors, capacitors, diodes, inductors, switches, registers, flipflops, digital logic, connections, traces, buses, semiconductor (e.g., silicon) devices and/or structures, processing devices, storage devices, memory devices, circuit boards, sensors, packages, substrates, housings, servers, client devices, computing devices, network devices, networks, combinations or variations of one or more of the same, and/or any other suitable components. In certain implementations, one or more of these additional circuits, components, and/or features can be inserted and/or applied between any of the existing circuits, components, and/or features illustrated in FIGS. 1-4 consistent with the aims and/or objectives described herein. Accordingly, the couplings and/or connections described with reference to FIGS. 1-4 can be direct connections with no intermediate components, devices, and/or nodes or indirect connections with one or more intermediate components, devices, and/or nodes.

In some examples, the phrase “to couple” and/or the term “coupling”, as used herein, refers to a direct connection and/or an indirect connection. For example, a direct coupling between two components constitutes and/or represents a coupling in which those two components are directly connected to each other by a single node that provides continuity from one of those two components to the other. In other words, the direct coupling excludes and/or omits any additional components between those two components.

Additionally or alternatively, an indirect coupling between two components constitutes and/or represents a coupling in which those two components are indirectly connected to each other by multiple nodes that fail to provide continuity from one of those two components to the other. In other words, the indirect coupling includes and/or incorporates at least one additional component between those two components. In one example, the indirect coupling includes and/or incorporates at least one additional computing device between two computing devices illustrated in any of FIGS. 1-4. In some implementations, one or more components and/or devices illustrated in FIGS. 1-4 can be omitted and/or excluded from the corresponding systems.

FIG. 5 is a flow diagram of an exemplary computer-implemented method 500 for event logging and reporting in video games. In one example, the steps shown in FIG. 5 are performed by circuitry incorporated into a server associated with a video game. Additionally or alternatively, the steps shown in FIG. 5 incorporate and/or involve certain sub-steps and/or variations consistent with the descriptions provided above in connection with FIGS. 1-4.

As illustrated in FIG. 5, method 500 includes and/or involves the step of obtaining, by a server associated with a video game, event definition data that defines an event to be logged in connection with the video game (510). Step 510 is performed in a variety of ways, including any of those described above in connection with FIGS. 1-4. For example, the server can receive the event definition data via a server-hosted user interface or derive the event definition data from a dynamic-events workflow based at least in part on a logged payload enqueued in a dead-letter queue.

Method 500 also includes and/or involves the step of generating, by the server based at least in part on the event definition data, code configured to cause a game runtime component to log instances of the event that occur in an instance of the video game (520). Step 520 is performed in a variety of ways, including any of those described above in connection with FIGS. 1-4. For example, the server can generate a language-specific code package initialized for a selected operating environment and embedding identifiers used to associate logged records with the modeled event.

Method 500 further includes and/or involves the step of providing, by the server, the code to the game runtime component (530). Step 530 is performed in a variety of ways, including any of those described above in connection with FIGS. 1-4. For example, the server can transmit the generated code package to a game client or game server that executes the instance of the video game.

Method 500 further includes and/or involves the step of receiving, by the server from the game runtime component, a record of an instance of the event that occurred in the instance of the video game (540). Step 540 is performed in a variety of ways, including any of those described above in connection with FIGS. 1-4. For example, the server can receive the record via a selected reporting mechanism (e.g., an SDK interface or a web API), publish the record to a telemetry topic, and/or implement a synchronization process to route the record into a designated analytical storage destination.

Method 500 further includes and/or involves the step of performing, by the server, an action in connection with the video game based at least in part on the record (550). Step 550 is performed in a variety of ways, including any of those described above in connection with FIGS. 1-4. For example, the server can update a configuration store consumed by the video game client to adjust gameplay parameters, generate a dashboard that visualizes records stored in an analytical storage destination, update matchmaking parameters or pairing rules to influence player pairing, and/or modify economy parameters or store offers in connection with the video game based at least in part on the record or an analysis of the record.

Furthermore, a non-transitory computer-readable medium comprises one or more computer-executable instructions that, when executed by circuitry of at least one computing device, cause the computing device to (1) obtain event definition data that defines an event to be logged in connection with a video game, (2) generate, based at least in part on the event definition data, code configured to cause a game runtime component to log instances of the event that occur in an instance of the video game, (3) provide the code to the game runtime component, (4) receive, from the game runtime component, a record of an instance of the event that occurred in the instance of the video game, and (5) perform an action in connection with the video game based at least in part on the record.

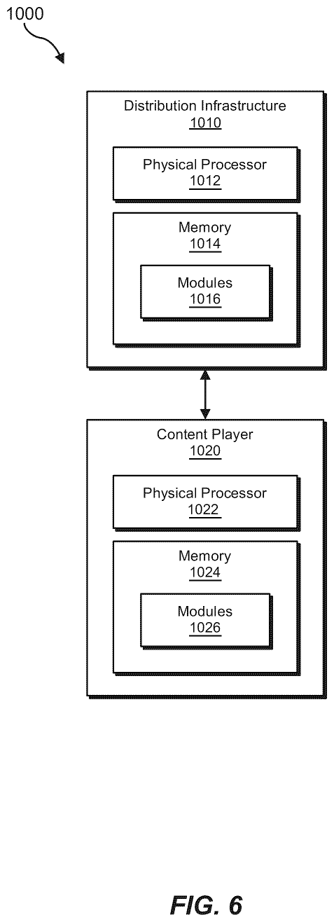

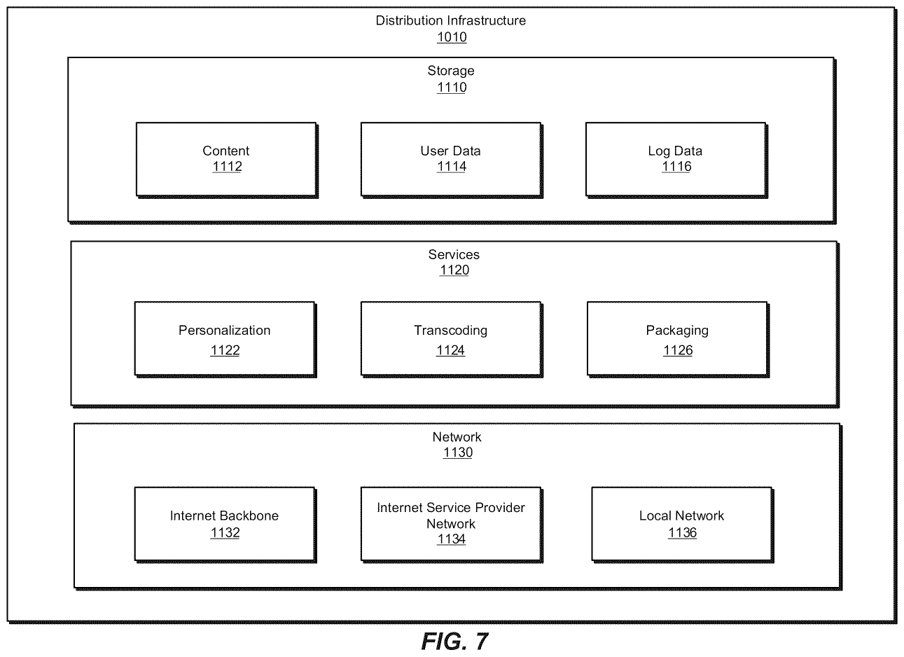

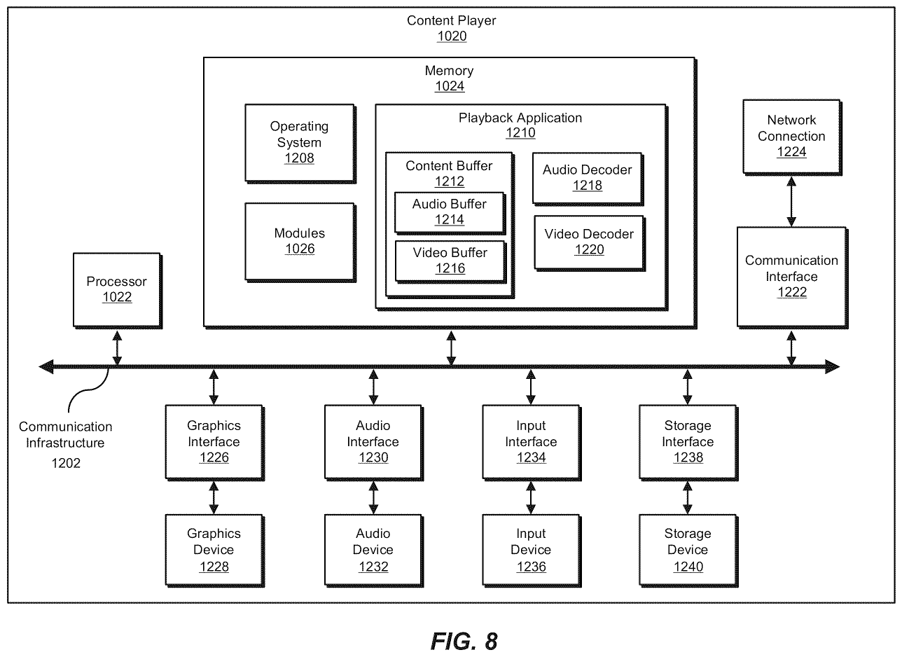

The following will provide, with reference to FIG. 6, detailed descriptions of exemplary ecosystems in which content is provisioned to end nodes and in which requests for content are steered to specific end nodes. The discussion corresponding to FIGS. 7 and 8 presents an overview of an exemplary distribution infrastructure and an exemplary content player used during playback sessions, respectively. These exemplary ecosystems and distribution infrastructures are implemented in any of the embodiments described above with reference to FIGS. 1-5.

FIG. 6 is a block diagram of a content distribution ecosystem 1000 that includes a distribution infrastructure 1010 in communication with a content player 1020. In some embodiments, distribution infrastructure 1010 is configured to encode data at a specific data rate and to transfer the encoded data to content player 1020. Content player 1020 is configured to receive the encoded data via distribution infrastructure 1010 and to decode the data for playback to a user. The data provided by distribution infrastructure 1010 includes, for example, audio, video, text, images, animations, interactive content, haptic data, virtual or augmented reality data, location data, gaming data, or any other type of data that is provided via streaming.

Distribution infrastructure 1010 generally represents any services, hardware, software, or other infrastructure components configured to deliver content to end users. For example, distribution infrastructure 1010 includes content aggregation systems, media transcoding and packaging services, network components, and/or a variety of other types of hardware and software. In some cases, distribution infrastructure 1010 is implemented as a highly complex distribution system, a single media server or device, or anything in between. In some examples, regardless of size or complexity, distribution infrastructure 1010 includes at least one physical processor 1012 and at least one memory 1014. One or more modules 1016 are stored or loaded into memory 1014 to enable adaptive streaming, as discussed herein.

Content player 1020 generally represents any type or form of device or system capable of playing audio and/or video content that has been provided over distribution infrastructure 1010. Examples of content player 1020 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 1010, content player 1020 includes a physical processor 1022, memory 1024, and one or more modules 1026. Some or all of the adaptive streaming processes described herein is performed or enabled by modules 1026, and in some examples, modules 1016 of distribution infrastructure 1010 coordinate with modules 1026 of content player 1020 to provide adaptive streaming of multimedia content.

In certain embodiments, one or more of modules 1016 and/or 1026 in FIG. 6 represent one or more software applications or programs that, when executed by a computing device, cause the computing device to perform one or more tasks. For example, and as will be described in greater detail below, one or more of modules 1016 and 1026 represent modules stored and configured to run on one or more general-purpose computing devices. One or more of modules 1016 and 1026 in FIG. 6 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 1012 and 1022 generally represent any type or form of hardware-implemented processing unit capable of interpreting and/or executing computer-readable instructions. In one example, physical processors 1012 and 1022 access and/or modify one or more of modules 1016 and 1026, respectively. Additionally or alternatively, physical processors 1012 and 1022 execute one or more of modules 1016 and 1026 to facilitate adaptive streaming of multimedia content. Examples of physical processors 1012 and 1022 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 1014 and 1024 generally represent any type or form of volatile or non-volatile storage device or medium capable of storing data and/or computer-readable instructions. In one example, memory 1014 and/or 1024 stores, loads, and/or maintains one or more of modules 1016 and 1026. Examples of memory 1014 and/or 1024 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 1010 according to certain embodiments. Distribution infrastructure 1010 includes storage 1110, services 1120, and a network 1130. Storage 1110 generally represents any device, set of devices, and/or systems capable of storing content for delivery to end users. Storage 1110 includes a central repository with devices capable of storing terabytes or petabytes of data and/or includes distributed storage systems (e.g., appliances that mirror or cache content at Internet interconnect locations to provide faster access to the mirrored content within certain regions). Storage 1110 is also configured in any other suitable manner.

As shown, storage 1110 can store a variety of different items including content 1112, user data 1114, and/or log data 1116. Content 1112 includes television shows, movies, video games, user-generated content, and/or any other suitable type or form of content. User data 1114 includes personally identifiable information (PII), payment information, preference settings, language and accessibility settings, and/or any other information associated with a particular user or content player. Log data 1116 includes viewing history information, network throughput information, and/or any other metrics associated with a user's connection to or interactions with distribution infrastructure 1010.

Services 1120 includes personalization services 1122, transcoding services 1124, and/or packaging services 1126. Personalization services 1122 personalize recommendations, content streams, and/or other aspects of a user's experience with distribution infrastructure 1010. Transcoding services 1124 compress media at different bitrates which, as described in greater detail below, enable real-time switching between different encodings. Packaging services 1126 package encoded video before deploying it to a delivery network, such as network 1130, for streaming.

Network 1130 generally represents any medium or architecture capable of facilitating communication or data transfer. Network 1130 facilitates communication or data transfer using wireless and/or wired connections. Examples of network 1130 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 1130 includes an Internet backbone 1132, an internet service provider 1134, and/or a local network 1136. As discussed in greater detail below, bandwidth limitations and bottlenecks within one or more of these network segments triggers video and/or audio bit rate adjustments.

FIG. 8 is a block diagram of an exemplary implementation of content player 1020 of FIG. 6. Content player 1020 generally represents any type or form of computing device capable of reading computer-executable instructions. Content player 1020 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 1022 and memory 1024, content player 1020 includes a communication infrastructure 1202 and a communication interface 1222 coupled to a network connection 1224. Content player 1020 also includes a graphics interface 1226 coupled to a graphics device 1228, an input interface 1234 coupled to an input device 1236, and a storage interface 1238 coupled to a storage device 1240.

Communication infrastructure 1202 generally represents any type or form of infrastructure capable of facilitating communication between one or more components of a computing device. Examples of communication infrastructure 1202 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 1024 generally represents any type or form of volatile or non-volatile storage device or medium capable of storing data and/or other computer-readable instructions. In some examples, memory 1024 stores and/or loads an operating system 1208 for execution by processor 1022. In one example, operating system 1208 includes and/or represents software that manages computer hardware and software resources and/or provides common services to computer programs and/or applications on content player 1020.

Operating system 1208 performs various system management functions, such as managing hardware components (e.g., graphics interface 1226, audio interface 1230, input interface 1234, and/or storage interface 1238). Operating system 1208 also provides process and memory management models for playback application 1210. The modules of playback application 1210 include, for example, a content buffer 1212, an audio decoder 1218, and a video decoder 1220.

Playback application 1210 is configured to retrieve digital content via communication interface 1222 and play the digital content through graphics interface 1226. Graphics interface 1226 is configured to transmit a rendered video signal to graphics device 1228. In normal operation, playback application 1210 receives a request from a user to play a specific title or specific content. Playback application 1210 then identifies one or more encoded video and audio streams associated with the requested title. After playback application 1210 has located the encoded streams associated with the requested title, playback application 1210 downloads sequence header indices associated with each encoded stream associated with the requested title from distribution infrastructure 1010. A sequence header index associated with encoded content includes information related to the encoded sequence of data included in the encoded content.

In one embodiment, playback application 1210 begins downloading the content associated with the requested title by downloading sequence data encoded to the lowest audio and/or video playback bitrates to minimize startup time for playback. The requested digital content file is then downloaded into content buffer 1212, which is configured to serve as a first-in, first-out queue. In one embodiment, each unit of downloaded data includes a unit of video data or a unit of audio data. As units of video data associated with the requested digital content file are downloaded to the content player 1020, the units of video data are pushed into the content buffer 1212. Similarly, as units of audio data associated with the requested digital content file are downloaded to the content player 1020, the units of audio data are pushed into the content buffer 1212. In one embodiment, the units of video data are stored in video buffer 1216 within content buffer 1212 and the units of audio data are stored in audio buffer 1214 of content buffer 1212.

A video decoder 1220 reads units of video data from video buffer 1216 and outputs the units of video data in a sequence of video frames corresponding in duration to the fixed span of playback time. Reading a unit of video data from video buffer 1216 effectively de-queues the unit of video data from video buffer 1216. The sequence of video frames is then rendered by graphics interface 1226 and transmitted to graphics device 1228 to be displayed to a user.

An audio decoder 1218 reads units of audio data from audio buffer 1214 and outputs the units of audio data as a sequence of audio samples, generally synchronized in time with a sequence of decoded video frames. In one embodiment, the sequence of audio samples is transmitted to audio interface 1230, which converts the sequence of audio samples into an electrical audio signal. The electrical audio signal is then transmitted to a speaker of audio device 1232, which, in response, generates an acoustic output.

In situations where the bandwidth of distribution infrastructure 1010 is limited and/or variable, playback application 1210 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 1226 is configured to generate frames of video data and transmit the frames of video data to graphics device 1228. In one embodiment, graphics interface 1226 is included as part of an integrated circuit, along with processor 1022. Alternatively, graphics interface 1226 is configured as a hardware accelerator that is distinct from (i.e., is not integrated within) a chipset that includes processor 1022.

Graphics interface 1226 generally represents any type or form of device configured to forward images for display on graphics device 1228. For example, graphics device 1228 is fabricated using liquid crystal display (LCD) technology, cathode-ray technology, and light-emitting diode (LED) display technology (either organic or inorganic). In some embodiments, graphics device 1228 also includes a virtual reality display and/or an augmented reality display. Graphics device 1228 includes any technically feasible means for generating an image for display. In other words, graphics device 1228 generally represents any type or form of device capable of visually displaying information forwarded by graphics interface 1226.

As illustrated in FIG. 8, content player 1020 also includes at least one input device 1236 coupled to communication infrastructure 1202 via input interface 1234. Input device 1236 generally represents any type or form of computing device capable of providing input, either computer or human generated, to content player 1020. Examples of input device 1236 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Content player 1020 also includes a storage device 1240 coupled to communication infrastructure 1202 via a storage interface 1238. Storage device 1240 generally represents any type or form of storage device or medium capable of storing data and/or other computer-readable instructions. For example, storage device 1240 is a magnetic disk drive, a solid-state drive, an optical disk drive, a flash drive, or the like. Storage interface 1238 generally represents any type or form of interface or device for transferring data between storage device 1240 and other components of content player 1020.

Many other devices or subsystems are included in or connected to content player 1020. Conversely, one or more of the components and devices illustrated in FIGS. 6-8 need not be present to practice the embodiments described and/or illustrated herein. The devices and subsystems referenced above are also interconnected in different ways from that shown in FIGS. 6-8. Content player 1020 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into content player 1020. All or a portion of the computer program stored on the computer-readable medium is then stored in memory 1024 and/or storage device 1240. When executed by processor 1022, a computer program loaded into memory 1024 causes processor 1022 to perform and/or be a means for performing the functions of one or more of the example embodiments described and/or illustrated herein. Additionally or alternatively, one or more of the example embodiments described and/or illustrated herein are implemented in firmware and/or hardware. For example, content player 1020 is configured as an Application Specific Integrated Circuit (ASIC) adapted to implement one or more of the example embodiments disclosed herein.

As detailed above, the computing devices and systems described and/or illustrated herein broadly represent any type or form of computing device or system capable of executing computer-readable instructions, such as those contained within the modules described herein. In their most basic configuration, these computing device(s) can each include at least one memory device and at least one physical processor.

In some examples, the term “memory device” generally refers to any type or form of volatile or non-volatile storage device or medium capable of storing data and/or computer-readable instructions. In one example, a memory device can store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor can access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein can represent portions of a single module or application. In addition, in certain embodiments one or more of these modules can represent one or more software applications or programs that, when executed by a computing device, can cause the computing device to perform one or more tasks. For example, one or more of the modules described and/or illustrated herein can represent modules stored and configured to run on one or more of the computing devices or systems described and/or illustrated herein. One or more of these modules can also represent all or portions of one or more special-purpose computers configured to perform one or more tasks.

In addition, one or more of the modules described herein can transform data, physical devices, and/or representations of physical devices from one form to another. Additionally or alternatively, one or more of the modules recited herein can transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein can be shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
obtaining, by a server associated with a video game, event definition data that defines an event to be logged in connection with the video game;
generating, by the server based at least in part on the event definition data, code configured to cause a game runtime component to log instances of the event that occur in an instance of the video game;
providing, by the server, the code to the game runtime component;
receiving, by the server from the game runtime component, a record of an instance of the event that occurred in the instance of the video game; and
performing, by the server, an action in connection with the video game based at least in part on the record.

2. The computer-implemented method of claim 1, further comprising storing, by the server, the record of the instance of the event in an analytical storage destination to facilitate analyzing the record, wherein performing the action comprises performing the action based at least in part on an analysis of the record.

3. The computer-implemented method of claim 2, wherein the game runtime component comprises a client executing the instance of the video game;
further comprising identifying, by the server, a unique identifier included in the event definition data, wherein:
generating the code comprises generating the code to cause the client to insert the unique identifier in the record of the instance of the event; and
storing the record in the analytical storage destination comprises designating the analytical storage destination to store records that include the unique identifier.

4. The computer-implemented method of claim 3, wherein:
the event definition data comprises a schema that models the event; and
the unique identifier corresponds to a specific version of the schema.

5. The computer-implemented method of claim 1, wherein the game runtime component comprises a client executing the instance of the video game;
further comprising identifying, by the server, a selected programming language and a type of operating environment indicated in the event definition data, wherein:
generating the code comprises generating a language-specific code package for execution in the selected programming language and initialized for the type of operating environment; and
providing the code to the game runtime component comprises providing the code package to the client for execution in the type of operating environment in connection with the instance of the video game.

6. The computer-implemented method of claim 5, wherein:
the selected programming language comprises at least one of:
an object-oriented language;
a mobile platform language;
a game engine scripting language; or
a visual scripting language; and
the type of operating environment comprises at least one of:
a production environment;
a staging environment;
a software development environment;
a sandbox environment; or
a quality assurance environment.

7. The computer-implemented method of claim 1, wherein the game runtime component comprises a client executing the instance of the video game;
further comprising identifying, by the server, a selected reporting mechanism in the event definition data, wherein:
generating the code comprises generating the code to cause the client to report the record of the instance of the event to the server via the selected reporting mechanism; and
receiving the record of the instance of the event comprises receiving the record of the instance of the event from the client via the selected reporting mechanism.

8. The computer-implemented method of claim 7, wherein the selected reporting mechanism comprises one of:
a software development kit (SDK) interface;
a web application programming interface (API); or
a client library interface.

9. The computer-implemented method of claim 1, further comprising creating, by the server, a per-event reporting pipeline based at least in part on the event definition data by:
creating a telemetry topic associated with the event;
designating an analytical storage destination to store records received via the telemetry topic; and
registering, on the server, a synchronization process configured to route the records received via the telemetry topic into the analytical storage destination.

10. The computer-implemented method of claim 9, wherein receiving the record of the instance of the event comprises:
publishing the record of the instance of the event to the telemetry topic; and
implementing the synchronization process to route the record from the telemetry topic into the analytical storage destination.

11. The computer-implemented method of claim 1, wherein the action comprises at least one of:
updating, by the server, a configuration store of the video game to adjust gameplay parameters based at least in part on the record;
rendering, by the server, a dashboard that visualizes records stored in an analytical storage destination, the records comprising the record of the instance of the event;
updating, by the server, matchmaking parameters or pairing rules to influence player pairing based at least in part on the record; or
modifying, by the server, economy parameters or store offers in connection with the video game based at least in part on the record.

12. The computer-implemented method of claim 1, wherein obtaining the event definition data comprises receiving the event definition data from at least one of:
a user interface that is hosted by the server and through which a user defines the event; or
a dynamic-events workflow from which the server derives the event definition data based at least in part on a logged payload loaded in a dead-letter queue.

13. A system comprising:
at least one storage device configured to store records of select events that occur in a video game; and
circuitry that is incorporated into a server associated with the video game, wherein the circuitry is configured to:
obtain event definition data that defines an event to be logged in connection with the video game;
generate, based at least in part on the event definition data, code configured to cause a game runtime component to log instances of the event that occur in an instance of the video game;
provide the code to the game runtime component;
receive, from the game runtime component, a record of an instance of the event that occurred in the instance of the video game; and
perform an action in connection with the video game based at least in part on the record.

14. The system of claim 13, wherein the circuitry is further configured to:
store the record of the instance of the event in an analytical storage destination of the storage device to facilitate analyzing the record; and
perform the action based at least in part on an analysis of the record.

15. The system of claim 14, wherein:
the game runtime component comprises a client executing the instance of the video game; and
the circuitry is further configured to:
identify a unique identifier included in the event definition data;
generate the code to cause the client to insert the unique identifier in the record of the instance of the event; and
designate the analytical storage destination to store records that include the unique identifier.

16. The system of claim 15, wherein:
the event definition data comprises a schema that models the event; and
the unique identifier corresponds to a specific version of the schema.

17. The system of claim 13, wherein:
the game runtime component comprises a client executing the instance of the video game; and
the circuitry is further configured to:
identify a selected programming language and a type of operating environment indicated in the event definition data;
generate a language-specific code package for execution in the selected programming language and initialized for the type of operating environment; and
provide the code package to the client for execution in the type of operating environment in connection with the instance of the video game.

18. The system of claim 13, wherein:
the game runtime component comprises a client executing the instance of the video game; and
the circuitry is further configured to:
identify a selected reporting mechanism in the event definition data;
generate the code to cause the client to report the record of the instance of the event to the server via the selected reporting mechanism; and
receive the record of the instance of the event from the client via the selected reporting mechanism.

19. The system of claim 18, wherein the selected reporting mechanism comprises one of:
a software development kit (SDK) interface;
a web application programming interface (API); or
a client library interface.

20. A non-transitory computer-readable medium comprising one or more computer-executable instructions that, when executed by circuitry of a server, cause the server to:
obtain event definition data that defines an event to be logged in connection with a video game;
generate, based at least in part on the event definition data, code configured to cause a game runtime component to log instances of the event that occur in an instance of the video game;
provide the code to the game runtime component;
receive, from the game runtime component, a record of an instance of the event that occurred in the instance of the video game; and
perform an action in connection with the video game based at least in part on the record.
